(19) United States
(12) Patent Application Publication
(10) Pub. No.: US 2005/0280533 A1
(43) Pub. Date: Dec. 22, 2005

(54) Apparatus for Automatic Height Measurement

(75) Inventor: Lixin Yao, Chapel Hill, NC (US)

Correspondence Address: Lixin Yao, 202 New Parkside Drive, Chapel Hill, NC, 27516, US

(73) Assignee: Lixin Yao Yao, Chapel Hill, NC (US)

(21) Appl. No.: 10/710,070

(22) Filed: Jun. 16, 2004

(51) Int. Cl. G08B 13/18

(52) U.S. Cl. 340/552; 340/573.1

(57) ABSTRACT

This invention provides a new and automatic way to measure the height of an object, such as a person. Currently, the common way of measuring a person's height is to use a ruler at home or a kind of retractable mechanical device at a doctor's office. The apparatus described in this invention employs signal transmitters and signal receivers, both standing on a horizontal surface where a person is in between. The transmitters emit signals to be received by the receives. Part of the signals are blocked by the person present in between. The highest point where there the signal can be received at the receivers indicates the person's height. The measured height is displayed at a device.

### BACKGROUND OF INVENTION

The present invention relates to a method and system for measuring a person's height at a place, such as home or doctor's office.

Presently, the common method of measuring a person's height at home is to use a ruler. Either to measure the person directly or have the person stand next to a wall, mark the wall and measure the marked point. At a doctor's office, a person is usually asked to stand on an equipment on which a sliding vertical ruler is installed. A nurse then adjusts the ruler to match the height of the person. The height can then be read on the ruler. Such methods are manual, slow and results need to be hand written down. When the person is a toddler, such methods are often ineffective since toddlers don't want to remain still.

There is need to have an automatic way of measuring a person's height without sliding, holding and writing.

### SUMMARY OF INVENTION

The present invention provides a way to measure a person's height conveniently, quickly and to display the result automatically.

The apparatus of present invention uses two signal processing ends, for example, two vertical bars. One bar is filled with an array of transmitting elements. Another bar is filled with an array of receiving elements. The frequency of the signal is such that the dispersion and refraction is minimal. The two bars stand on same horizontal surface. The receiving elements are calibrated with height. The output of the elements is read by a controller. Such output is either 0 or 1.0 means no signal, 1 means signal is present. Each receiving element is marked with an identification (ID) which correlates to a height. Lets say, the bigger ID is, the higher the element is. The controller reads the receiving elements starting with the element with biggest possible ID. When one elements returns 0 and the following certain number of elements (20 for example), also return 0, the element with the biggest ID returning 0 indicates the height. The controller then looks up a table for the height according the ID. The table contains pairs of values of receiver ID and height.

The controller then displays the result of the height on a LCD or LED. The result can be printed to paper on a printer. The result can also be saved in non-volatile media, such as a disk drive. Alternatively, the result can be sent in packets to a computer for further processing. The results can be displayed either in English or metric units depending on selection of a switch.

The displaying device can be physically attached to the measuring unit. The controller can also send the result via wireless communication to a processing center. The controller has capability to record certain number of measurements.

The apparatus is powered by AC or DC. The apparatus is equipped with a switch, so it can be turned on or off. The apparatus is equipped with another switch, so it can operate or stop operation while the power is on.

The transmitting and receiving elements are densely populated to ensure the accuracy of the measurement.

### BRIEF DESCRIPTION OF DRAWINGS

FIG. 1 shows the state of the automatic height measurement apparatus of the current invention when power is off

FIG. 2 shows alignment of the apparatus of present invention.

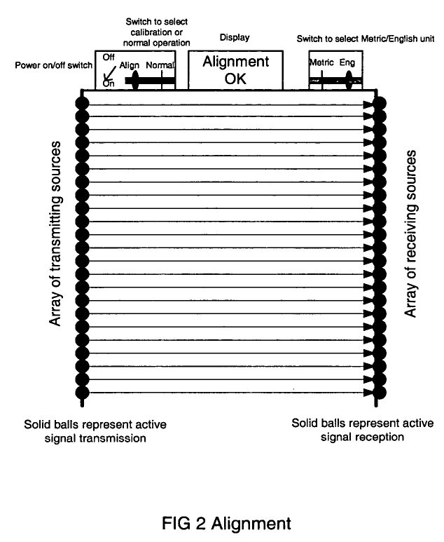

FIG. 3 shows measurement of a person's height while the person is standing still using the apparatus of present invention.

FIG. 4 shows measurement of a person's height while the person is sitting using the apparatus of present invention.

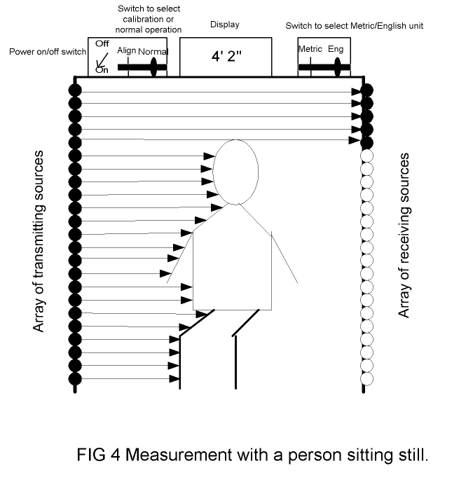

FIG. 5 shows measurement of a person's height while the person is walking through using the apparatus of present invention.

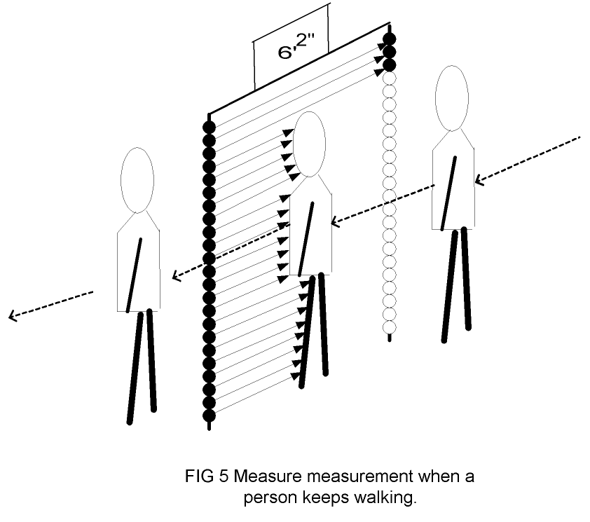

FIG. 6 shows signal patterns of two consecutive but separate height measurement using the apparatus of present invention.

FIG. 7 shows power saving mode of the apparatus of present invention.

FIG. 8 shows measurement of a person's height using only one pair of transmitter and receiver on the apparatus of present invention

### BRIEF DESCRIPTION OF SEQUENCES

The apparatus needs to be installed. Then turn on the power switch and align the transmitter and receivers on the apparatus. Then switch to normal operation for height measurement and select Metric or English unit for height display. Have a person stand between the transmitting and receiving arrays and leave the apparatus, the height will be shown on the display.

### DETAILED DESCRIPTION

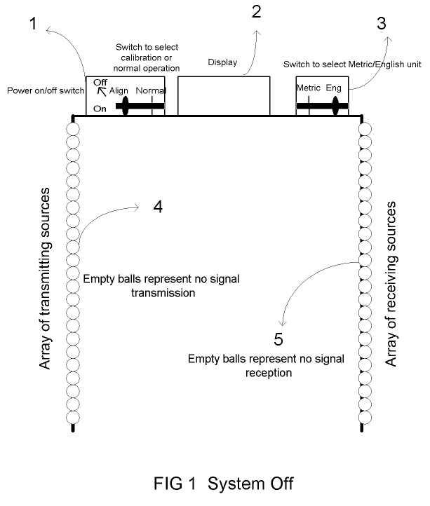

As FIG. 1 shows, the height measurement apparatus contains power switch 1, selection switch 2 for Alignment or Normal Operation, selection switch 3 for using Metric units or English units on display, an array of transmitting sources 4, and an array of receiving sources 5.

In a preferred embodiment, an array of infrared through-beam transmitters can be used as transmitting sources. An array of infrared through-beam receivers can be used as receiving sources. Given no interference between adjacent receivers, the more transmitters/receivers are used, the higher accuracy the height measurement is. The space between transmitters is same as the space between receivers. The space is such that there is no interference between two adjacent receivers. However, due to the method used in this invention, which is to detect signal presence or absence, given signals with short wavelength such as infrared light, the interference between adjacent receivers is not show stopping. When a person is present, the lower receivers always show no signal, while the higher receivers show signal. Only at the boundary around the highest point of a person, the possible interference weighs in. To achieve good resolution of height, a Class I laser (not hazardous for continuous viewing) can be used. If using a Class I laser, the diameter of the light spot generated by a narrow beam transmitter can be well below 1 cm when it reaches the receiver. So the error of height measurement is below 1 cm.

Each receiver corresponds to a height. For example, receiver #1 correlates to 0.5 cm, receiver #2 correlates to 1 cm, receiver #3 correlates to 1.5 cm, etc.

Before use, the apparatus needs to be properly installed and aligned. The purpose of alignment is to have each pair of the transmitter and receiver aimed at each other. Turn on power, and turn the switch 2 to “Align”. The controller knows the system is in alignment state and checks if all receivers indicate signal presence. If yes, “OK” is displayed on the display, otherwise, “NOT OK” could be displayed. Installer needs to adjust the positions of transmitting and receiving bars to make sure the display shows “OK”.

Once “OK”, switch 2 can be switched to “Normal” for normal operation. And switch 3 can be used to select either to display Metric or English units on the display.

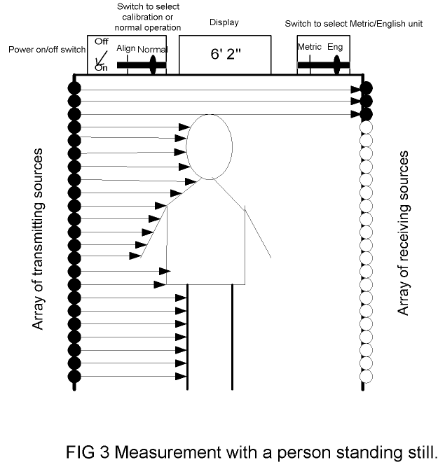

Now the apparatus is ready for measuring a person's height. As FIG. 3 shows, when a person is between the transmitting and receiving bars, controller detects no signal is received in the lower receivers, the highest receiver which can receive signal indicates the height of the person. If the distance between receiver is 0.5 cm, and #1 is the number of the receiver at bottom, if receivers bigger than #359 show signal, then the person's height is 360*0.5 cm=180 cm.

One interesting use of the apparatus of present invention is not to have a person stand still in the middle. The person can walk though. The controller keeps tracking changes of received signals and it always uses the highest receiver showing signal presence. A walking person always has a highest point. Therefore, the apparatus will tell the height. The height may be slightly less than the actual height due to different ways people walk. In this case, the apparatus provides a close estimate. This is particularly helpful for measuring a toddler's height.

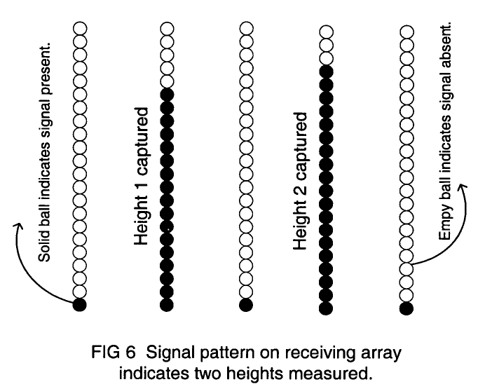

How to separate one measurement from another? Controller tracks the highest receiver with signal. When another measurement is coming, the number of the highest receiver goes down, assuming the smaller number is, the lower the receiver is. The receiver number of the highest receiver with signal will hit a bottom before increasing again. This bottom is the indication of the start of a new measurement. With this mechanism, no manual invention is needed while measurement is ongoing. The display will show one height after another, regardless people being measured are standing are moving. And the results can be stored in controller or sent to a remote computer via wired or wireless connection. The signal pattern for two consecutive capture of heights is shown in FIG. 6.

As long as a person is present between the transmitting and receiving arrays, there is no requirement where on the line the person needs to be. The apparatus of present invention will find the height.

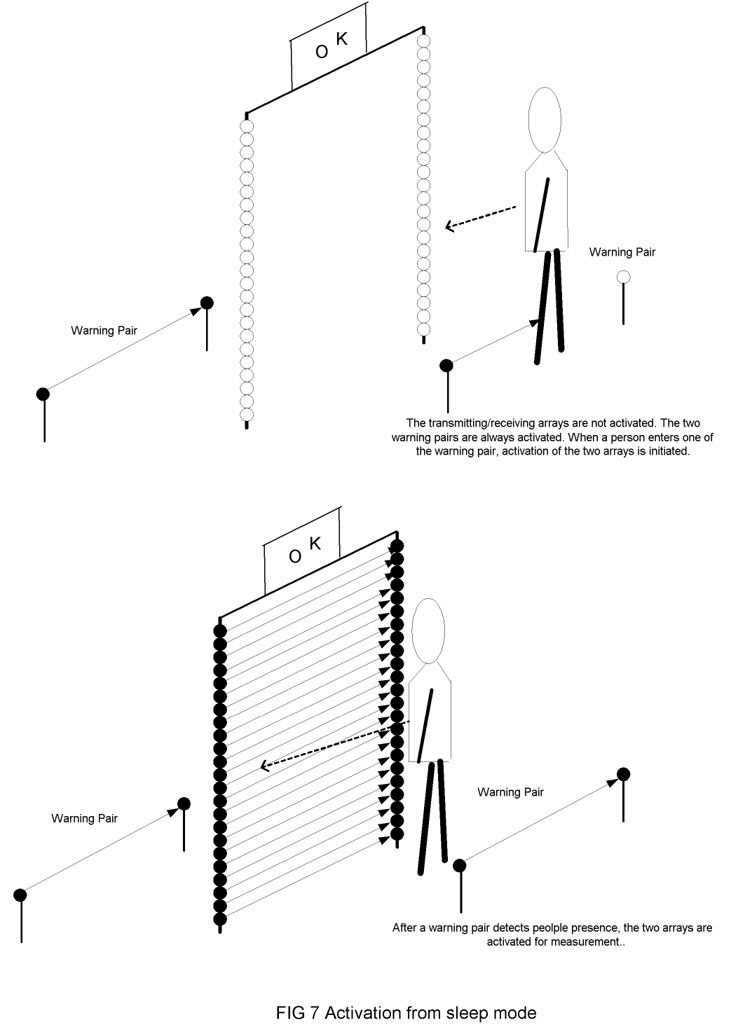

To save power, the transmitting and receiving arrays can be in sleep mode (no active transmission and receiving of signals). As FIG. 7 shows, when one of the two warning pairs of transmitters/receivers indicate people presence, the arrays are then activated to start measurement. A timer (for example, 30 seconds) is then started, if the warning transmitters/receivers report no people presence when timer expires, and if the transmitter/receiver arrays report no people presence, the arrays go to sleep mode.

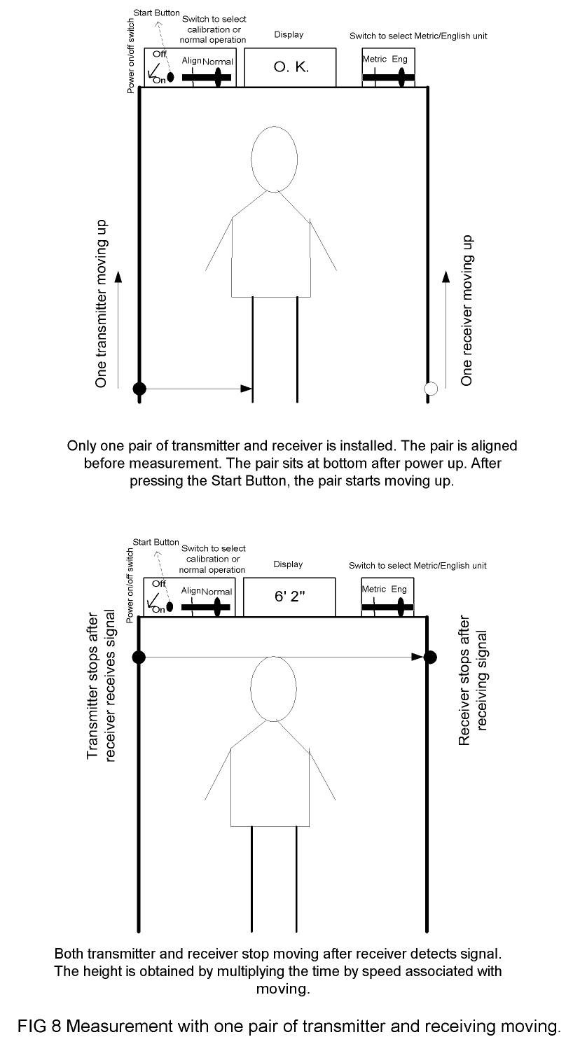

To save cost, use only one pair of transmitter and receiver, as FIG. 8 shows. At beginning of operation (switch at “Normal”), the pair is at bottom of the apparatus. When a person is between the transmitter and receiver, pressing “Start Button” causes the pair to move on the apparatus, the controller knows the speed and tracks the time spent between start of moving and detection of signal at receiver. The height of the person is calculated by multiplying the speed by the time. The pair is moved back to bottom after height is known. This low cost mode requires the person to be still between the transmitter and receiver. A moving object can not be measured accurately.

1. A method of measuring an object's height. The method employs transmitters and receivers, both placed vertically. Transmitters transmit signals to be received by receivers. An object is present between transmitters and receivers. The bottom part of the transmitted signals is blocked by the object. The highest receiver where the signal is present shows the height of the object. The height is then displayed on a device.

2. The method of claim 1 wherein the object is a person.

3. The method of claim 1 wherein the object is an obstacle other than a person.

4. The method of claim 1 wherein the transmitters or receivers are discretely placed.

5. The method of claim 1 wherein the transmitters or receivers are continuously placed.

6. The method of claim 1 wherein the signal is electromagnetic.

7. The method of claim 1 wherein the signal is sonic.

8. The method of claim 1 wherein the signal is optical, either visible or invisible.

9. The method of claim 1 wherein the displaying device is a Liquid Crystal Display (LCD) device.

10. The method of claim 1 wherein the displaying device is a Light Emitting Display (LED). device.

11. The method of claim 1 wherein the displaying device is a printer.

12. The method of claim 1 wherein the displaying device is a speaker.

13. The method of claim 1 wherein the displaying device is a computer.

14. The method of claim 1 wherein the displaying device is connected to the controller via wired or wireless communications.

15. The method of claim 1 wherein the object remains still between the transmitters and receivers.

16. The method of claim 1 wherein the object moves through between the transmitters and receivers.

17. The method of claim 1 wherein the signal is transmitted constantly during time of measurement.

18. The method of claim 1 wherein the signal is transmitted in pulses during time of measurement.

19. The method of claim 1 wherein only one transmitter and one receiver are used and they move in order to detect signal presence during time of measurement.

20. An apparatus for measuring an object's height. The apparatus comprises a signal generator mounted on a vertical surface higher than the object's height, and a signal detector mounted on another vertical surface also higher than the object's height, a programmable controller to determine the object's height based on the position of the highest point on the detector where the signal is received.
